(19) United States
(12) Patent Application Publication
(10) Pub. No.: US 2008/0115208 A1
(43) Pub. Date: May 15, 2008

(54) Multi-Factor Authentication System and a Logon Method of a Windows Operating System

(75) Inventor: Wei-Yuan Lee, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ARACHNOID BIOMETRICS IDENTIFICATION GROUP CORP., Taipei City (TW)

(21) Appl. No.: 11/626,963

(22) Filed: Jan. 25, 2007

(30) Foreign Application Priority Data
Oct. 25, 2006 (CN) 200610149829.3

(51) Int. Cl. G06F 12/14; H04L 9/00; H04L 9/32; G06F 12/00; H04K 1/00; G06F 13/00; G06F 17/30; G06F 7/04; G06F 7/58; G06K 19/00; G11C 7/00

(52) U.S. Cl. 726/19; 726/18; 713/182; 713/183

(57) ABSTRACT

A multi-factor authentication system and a logon method for a Windows operating system are provided. The system and method thereof are essentially applied to a Windows Vista™ operating system. Without any influence upon the common usage of a user, a multi-factor authentication window is established on a logon screen of the Windows operating system, so as to establish a more secure and convenient logon method. The system includes means for logging on to a Windows OS via a logon program “Winlogon.exe”, means for calling “LogonUI.exe” by the “Winlogon.exe”, means for certifying a user by a credential provider, means for displaying the logon screen having the multi-factor authentication window, means for authenticating via multiple factors, means for identifying a user by comparing the user ID with the user's information in a database, means for refilling the user ID/password, and means for messaging.

This application claims priority to China patent application No. 200610149829.3 filed on 25 Oct. 2006, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a multi-factor authentication system and a logon method, and especially relates to a customized multi-factor authentication and logon method for the Windows Vista™ operating system.

2. Descriptions of the Related Art

Windows® OS is a multi-user disk operating system in widespread use. It provides several logon methods for user authentication, and establishes a secure and encrypted operation environment for the system and data.

Except for the conventional Windows® operating system, the soon-to-be-released Windows Vista™ operating system adopts a completely different authentication method from the prior Windows® OS. Please refer to the official Microsoft® web site for the public technical document.

A user account control (UAC) is used for managing the user's privileges to the Windows Vista™ OS. The user's privilege management balances the flexibility and functionality for the administrator and security for general users.

The new authentication module implemented in the Windows Vista™ operating system provides a LogonUI process a direct communication to a Winlogon procedure. The authentication module provides a simple, scalable and flexible authentication procedure, and abandons the GINA module used for users' management of the prior Windows OS such as Windows XP® or Windows 2000®. It is different from the authentication means of the GINA module since a programmer doesn't need to create a new authentication environment by modifying any present user interfaces or logon windows. In particular, the Windows Vista™ operating system provides a credential provider module for communicating with the Windows logon screen, whereby a credential is retrieved and transferred to the Winlogon procedure, before a user logs on to the OS.

Other than the authentication method in which a user ID and password are used in the conventional method for logging on to the operating system, the above-mentioned Windows Vista™ operating system provides another approach for a programmer to logon to the system. The approach uses biometrics. The mentioned credential provider module is an additive module, which provides credentials for multiple users. The credentials, such as the ID/Password and smart card used in the Windows Vista™ OS, coexist in the operating system.

Accordingly, besides the authentication method provided by the operating system, a third party can still incorporate the other customized authentication services into the credential provider provided by the Windows Vista™ OS. For example, the credential indicating the smart card provided by the third party can be incorporated into the LogonUI. Furthermore, the biometric credential is implemented by palm print, iris scan, retina, facial, auricle, voiceprint, fingerprint or vein distribution of a finger, a palm, the back of a hand, etc. Besides the above-mentioned credentials used in the same logon screen provided by the Windows OS, the conventional authentication method using the ID/Password can also be used to perform the logon procedure.

The logon authentication structure of the Windows Vista™ OS is shown as the schematic diagram of FIG. 1. This structure includes a Winlogon procedure (11), which manages the logon authentication, after booting the system. Next, the procedure calls the program “LogonUI.exe” (13), so as to create a logon screen and retrieve information about the registered user of the Windows Vista™ operating system. In other words, the program “LogonUI.exe” can retrieve one or more credential information. Reference is made to this diagram, where the program “LogonUI.exe” (13) retrieves the information of credentials from credential provider 1 (151) and the credential provider 2 (152) through a well-defined interface. Each credential is presented as a tile shown on the logon screen by means of the program “LogonUI.exe” (13). The tile is provided for users to click to process the logon authentication. In an exemplary case using a default password credential provider, all the credentials provided for password logon can be retrieved after loading the password credential provider via the program “LogonUI.exe” (13).

After that, the tiles and IDs indicating the credentials are shown on the logon screen. After clicking one of the credentials, the program “LogonUI.exe” (13) queries the password credential provider through the defined interface about the account information and password field to be shown on the logon screen. The password field is provided for users to input a password (17). After the password credential provider retrieves the inputted password and identifies the user, an authentication package is generated, and the program “LogonUI.exe” (13) then returns it back to the Winlogon procedure. Subsequently, a Local Security Authority (LSA) (19) submits the above data to a Security Accounts Manager (SAM) database, where the data is authenticated. The Security Accounts Manager is a database used to store information of all the credentials having users' IDs and passwords.

### SUMMARY OF THE INVENTION

The above-mentioned Windows Vista™ operating system uses a credential provider to perform every kind of user authentication. Besides the original credential using a set of user ID/password or smart card, other customized authentication methods such as biometric authentication are required to create a proprietary credential. Nevertheless, in order to prevent any influence upon the user's behavior, the present invention creates a new credential provider for generating a multi-factor window on the logon screen. Moreover, the multi-factor authentication system is a more secure and convenient logon method.

The multi-factor authentication system of the preferred embodiment of the present invention includes a means for identifying a user by comparing the user ID generated by the multi-factor authentication procedure with the registered user's information in an authentication database. The system further includes a means for authentication using the credential provider to manage the system users. The system further includes a means for refilling the user ID and password, which are generated from the multi-factor authentication procedure, to the input fields of ID/password in the Windows logon procedure. The system further has a means for messaging, whereby a message communication channel transmits messages between the multi-factor authentication procedure and the credential provider.

The present invention is essentially applied for the user authentication in the Windows Vista™ operating system. The method of the preferred embodiment includes loading the Windows OS after booting the system. In the meantime, the system program “Winlogon.exe” activates a Windows logon procedure. After that, “Winlogon.exe” calls another program “LogonUI.exe”, so as to process the procedure for the logon screen. Next, the method has the step of loading a standard password credential provider of the Windows OS, and a customized credential provider of the multi-factor authentication module.

The program “LogonUI.exe” calls the APIs for each credential provider to represent the interactive environment as the user logs on to the operating system. When the program “LogonUI.exe” calls the customized credential provider, this credential provider can display a multi-factor window on the logon screen. After that, a message communication channel, which is implemented by a “Pipe” mechanism, a “Message” mechanism, or a “Shared Memory” mechanism, is established between the multi-factor authentication procedure and the customized credential provider.

Moreover, the credential provider of the method will create a wrapped password credential provider. Then the program “LogonUI.exe” calls API: GetCredentialCount( ) to retrieve the number of credentials provided by the credential provider(s). In the meantime, the parameters, count=0 and AutoLogonWithDefault=False, are returned from this customized credential provider. Next, the multi-factor authentication procedure is processed. The user is identified by comparing the input data generated by the multi-factor authentication procedure with the registered user's information in an authentication database. Then, the ID/Password of the identified user is retrieved from the authentication database and sent out through the message communication channel.

The program “LogonUI.exe” refreshes all the credentials provided by the credential provider as the customized credential provider receives the user ID/Password through the message communication channel. After that, the customized credential provider calls the previously mentioned wrapped password credential provider for retrieving the number of credentials and their information. Next, the user ID is compared with the credential of the registered user. If matched, a customized credential of that user and a wrapped password credential are generated instantly. In the meantime, the API: GetCredentialCount( ) returns count=1 and AutoLogonWithDefault=true.

Next, the program “LogonUI.exe” calls GetCredentialAt( ), and the customized credential is returned. The program “LogonUI.exe” automatically processes the logon procedure using the customized credential that the default value defines. The customized credential refills the password with the corresponding user into the password field of the wrapped password credential. In the meantime, the customized credential retrieves an authentication package from the wrapped password credential. After that, the authentication package is sent to the LogonUI procedure.

### BRIEF DESCRIPTION OF THE DRAWINGS

FIG. 1 shows a schematic diagram of an authentication mechanism for Windows Vista™ operating system;

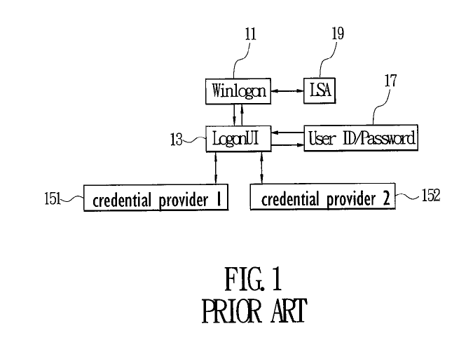

FIG. 2A shows the logon screen having a fingerprint authentication window of the present invention;

FIG. 2B shows the logon screen for inputting password after one credential tile is selected;

FIG. 3 shows the logon screen having a multi-factor authentication window of the present invention;

FIG. 4 shows a schematic diagram of the multi-factor authentication mechanism of the Windows OS;

FIG. 5 shows a schematic diagram of a credential provider and a customized credential provider of the operating system;

FIG. 6 shows a flowchart of the multi-factor authentication procedure; and

FIG. 7 shows a flowchart of the preferred embodiment of the multi-factor authentication procedure.

### DESCRIPTION OF THE PREFERRED EMBODIMENT

For further understanding of the invention, please refer to the following detailed description illustrating the embodiments and examples of the invention. The description is only for illustrating the invention and is not intended to be considered limiting the scope of the claim.

Microsoft® recently announced a new mechanism, named Winlogon Re-Architecture, which is used for a credential provider implementing the user authentication of Windows Vista™ operating system. This credential provider replaces GINA which was used by Windows® XP/2000. In particular, the multi-factor authentication system and a logon method of the Windows® OS mentioned in the present invention improves upon the above-mentioned new mechanism provided by Windows Vista™ OS. In this approach, the credentials generated for every user adopt the authentication method with a regular user ID/Password. Moreover, except for the credential generated under the authentication mechanism of the default credential provider using the corresponding user ID/Password, no other authentication method is provided. If another third-party authentication other than the default method is used, such as biometric verification or the like, a specific user credential used for the third-party authentication is generated.

Nevertheless, the system and the logon method disclosed in the present invention changes the conventional Windows® logon procedure. The present invention retrieves the authentication information from the system, and replaces it with authentication information of the multi-factor authentication. Furthermore, the provided method will not change the user's behavior, and the existing credentials of the operating system can use the multi-factor authentication smoothly. The multi-factor authentication is similar to types of biometric verification or a smart card, thus a multi-factor authentication window is created on the logon screen of the Windows OS for a more convenient and secure authentication.

The mentioned Windows Vista™ operating system supports an interactive logon method. A logon program “Winlogon.exe” is used to manage the authentication logon tactics of the Windows® OS, to keep and transmit signals, and to maintain the status of the OS, such as the welcome screen, login, logout, and workstation lock.

The multi-factor authentication system and logon method for Windows® OS of the present invention changes the conventional logon procedure, such as retrieving the authentication information during the logon processes of the program “LogonUI.exe”, and creating a customized logon procedure. The multi-factor authentication procedure is generated instantly. Consequently, the present invention creates the multi-factor authentication window on the logon screen without any change of the user's behavior.

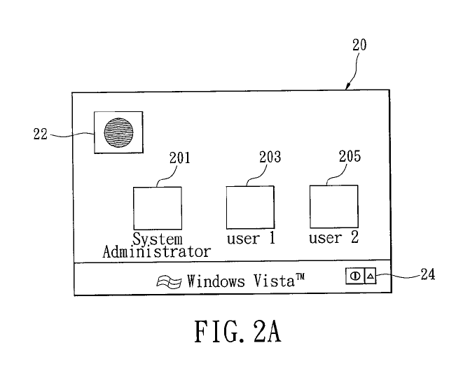

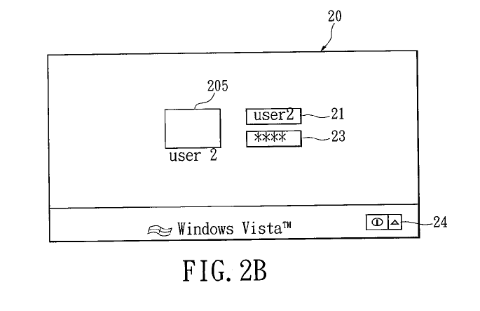

Reference is made to FIG. 2A which shows a logon screen of the Windows Vista™ operating system with a multi-factor authentication application. The present invention loads the Windows logon procedure after booting the operating system. Next, the program “LogonUI.exe” is called for generating a logon screen 20, which shows one or a plurality credentials used in Windows Vista™ operating system, such as the user 1 (203) and user 2 (205) as shown in the diagram. The items shown in the diagram below include a system menu 24 having a plurality of system instructions, such as reboot, suspend, shutdown and the like.

The logon screen created by the program “LogonUI.exe” is modified, and shows a multi-factor authentication window 22 in a specific position. Therefore, the user can use the multi-factor authentication window 22 to login to the operating system by means of the modified logon screen without changing their regular behavior.

In default, as the user chooses and clicks one credential such as user 2 (205), the tile becomes larger or displays other similar effects. After that, the next authentication screen shown in FIG. 2B display the user ID (or name) 21 and prompts the user to key in the corresponding password 23, whereby the user can perform the logon procedure.

The present example shows an authentication method which utilizes a fingerprint scanner to scan the user's fingerprint. The scanned fingerprint is used to do the comparison of its characteristics as the authentication procedure. The preferred embodiments of the multi-factor authentication means include a smart card (IC card) requiring an access code or an ID, a token card, or biometric verification obtained via a palm print, iris, retina, facial, auricle, voiceprint, fingerprint, vein distribution, and the other equivalent like.

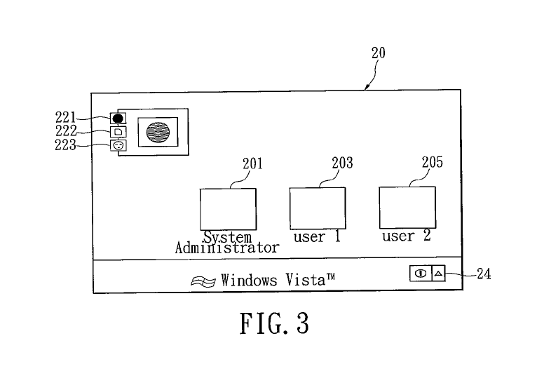

FIG. 3 shows another embodiment of the present invention. The multi-factor authentication window 22 shown on the logon screen 20 has a plurality of graphic items indicating a plurality of multi-factor authentication functions. The user can choose a suitable authentication way. There is a fingerprint icon 221, an IC card icon 222 and a facial icon 223 shown as the authentication items on the logon screen. The retrieved authentication information or biometric feature corresponds to a set of user ID/password by means of identity comparison. After the comparison, the ID/password is applied to the authentication and logon procedure through a password credential provider. Users can choose and perform any computer system supported authentication method to process the logon procedure without change of previous behavior since the multi-factor authentication window 22 is shown on the same logon screen as before.

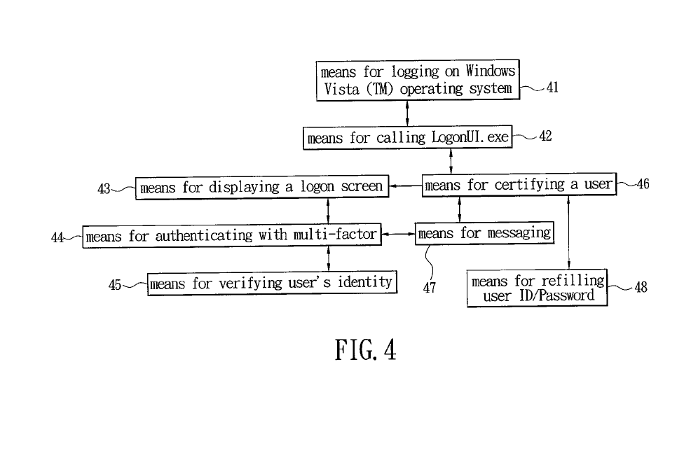

The present invention is different from the third-party provided authentication mechanism in that it firstly creates its own credential provider, which is suggested in the public technical document of Windows Vista™ OS. In particular the present invention modifies the logon procedure, and incorporates the provided multi-factor authentication procedure. After that, the original user can perform the multi-factor authentication procedure without change of his account or behavior. The multi-factor authentication system of Windows® OS is shown as the schematic diagram of FIG. 4.

What follows is the essential means of the present invention:
1. Windows logon means (Winlogon) 41, which loads the Windows Vista™ operating system after booting the computer system. The program “Winlogon.exe” establishes a Windows logon procedure, which is a logon management program of the Windows® OS. “Winlogon.exe” manages the logon operation using a user ID/password, and thereby builds a secure login/logout management procedure.
2. LogonUI means 42, wherein a program “LogonUI.exe” is executed since a LogonUI procedure is called by the above Windows logon procedure. This LogonUI means retrieves the credential information of Windows Vista™ OS, and shows it on the Windows logon screen.
3. The logon screen displaying means 43, wherein a customized credential provider is installed by the program LogonUI.exe, at this time there is a multi-factor authentication window shown on the logon screen.
4. The multi-factor authentication means 44. The above logon screen displaying means creates a multi-factor authentication procedure, and processes the multi-factor authentication on the authentication window. The method thereof can be a smart card having a password or an ID request, a token card, or biometric verification, for example, a palm print, iris, retina, facial, auricle, voiceprint, fingerprint, vein distribution of fingers/palm/back of hand, or the like. For example, a fingerprint scanner is used to scan the fingerprint for operating the multi-factor authentication procedure.
5. User Identification means 45. The user information produced by the multi-factor authentication procedure is compared with the user's information registered in an authentication database for identifying the user. In another embodiment, the user information corresponds to a set user ID/password, which is sent to the customized credential provider. Namely, the authentication procedure is applicable to the user identification.
6. Certification means 46 which manages the users of Windows Vista™ OS. The above mentioned credential provider describes the user interface of each credential, and sends the collected credential information to the LogonUI procedure. After that, a logon screen is created (by a logon screen displaying means). The credential provider can provide many users credentials, such as credentials using common ID/password or using a smart card. Beside the authentication methods the operating system provides, the third party can also add other authentication services via the credential provider. For example, a smart card credential, or a credential provider of the multi-factor authentication the present invention provides is added into the Windows logon screen.
7. User ID/password refilling means 48, as in the process of multi-factor authentication. The user information generated by the authentication procedure with the corresponding user ID/password stored in the authentication database is refilled into the fields for the user ID/password.
8. Messaging means 47, which transmits information between the multi-factor authentication procedure and the credential provider through a message communication channel. The user ID/password is also transmitted to the credential provider through the channel. For example, when a user inputs his or her fingerprint through the multi-factor authentication window and passes the verification, the credential provider is informed through this message communication channel. Next, the LogonUI procedure refreshes all the credential providers.

The above-mentioned messaging means includes schemes as follows:
1. A pipe mechanism, which embodies the signal transmission between the multi-factor authentication procedure and the Windows Vista™ OS logon procedure. A standard output for a pipe-front procedure is guided to a standard input for a pipe-back procedure. For example, the characteristic value read from the smart card, the scanned fingerprint or the biometric verification of the multi-factor authentication procedure is transmitted to the authentication procedure of the Windows® operating system through this pipe mechanism.
2. A message mechanism for the Windows® operating system, which can query or receive messages in a message queue. The message mechanism provides the multi-factor authentication procedure to transmit characteristic values from the smart card, scanned fingerprint or biometric verification to the Windows® logon procedure.
3. A shared memory mechanism, which uses a shared memory to process the characteristic values read from the smart card, scanned fingerprint, or biometric verification.

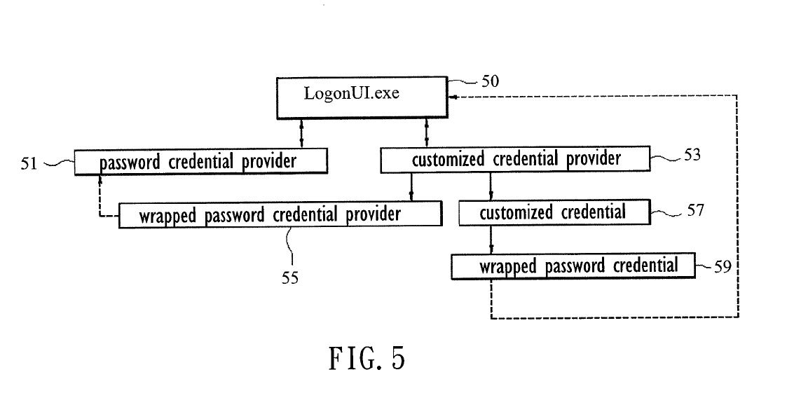

Reference is made to FIG. 5, which shows a schematic diagram of the credential provider using the multi-factor authentication method. The multi-factor authentication method firstly creates a customized credential provider 53, which coexists with the other credential provider(s) 51 originally used for Windows Vista™ OS. Moreover, the method loads the password credential provider 51 of the operating system and the customized credential provider 53 of the present invention via the program “LogonUI.exe” 50.

The customized credential provider 53 generates a wrapped password credential provider 55 so as to provide a simulated password credential provider 51 to the operating system as processing the authentication by the customized credential provider 53. Therefore, the multi-factor authentication method also uses the original password authentication system naturally, thereby the user ID/password of the logon account is met by verifying the multi-factor authentication.

When the customized credential provider 53 receives the user ID/password through the message communication channel and then verifies the credential, a customized credential 57 and a wrapped password credential 59 are created. After that, the customized credential 57 refills the corresponding password to the wrapped password credential 59, and calls an API of the wrapped password credential 59. After receiving the authentication package, the method performs a logon procedure as the authentication packet is transmitted to the program “LogonUI.exe” 50.

### Embodiment 1

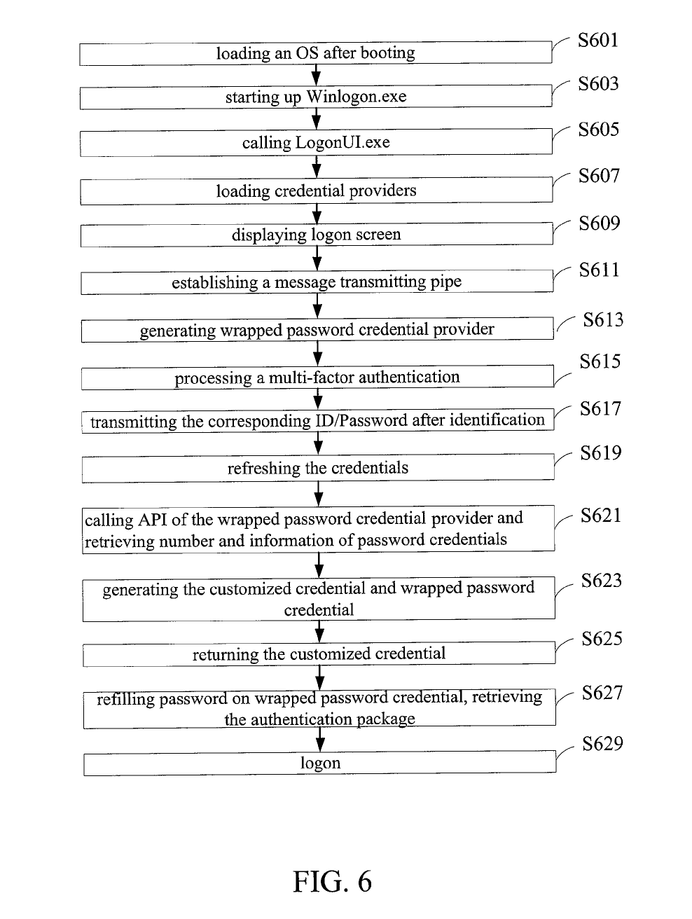

To make use of the above-mentioned means, as shown in FIG. 6, the multi-factor authentication method of the present invention essentially has the following steps: Firstly, the process loads an operating system by booting the system (S601), and enters the Windows® logon procedure (Winlogon). That is, a logon program “Winlogon.exe” activates the Windows® logon procedure. The “Winlogon.exe” manages the logon procedure for the Windows Vista™ operating system (S603).

Next, the program “Winlogon.exe” calls a program “LogonUI.exe” (S605). This program “LogonUI.exe” manages all parameters of Windows logon screen. Next, the program “LogonUI.exe” loads all the credential providers, which includes the password credential provider provided by Windows® OS and the customized credential providers of the present invention. Through some parameters, the program “LogonUI.exe” retrieves the information of one or more than one credentials, which are the registered accounts in the Windows Vista™ operating system. The parameters are CPUS_LOGON for users logging on by selecting the listed account, CPUS_UNLOCK_WORKSTATION for users unlocking the computer, CPUS_CREDUI for “User Account Control” (S607).

The program “LogonUI.exe” is used to display the logon screen, which includes the multi-factor authentication window of the preferred embodiment of the present invention. The authentication window further has tiles or account names shown on the logon screen for indicating different credentials. Those are used for users to perform the logon authentication (S609).

Next, a message communication channel is established between the multi-factor authentication window and the credential providers (S611). The message communication channel is used for transmitting information about the credentials, retrieving user IDs/passwords corresponding to the multi-factor authentication. Furthermore, the message communication channel can be implemented as a pipe mechanism, a message mechanism, or a shared memory mechanism.

A wrapped password credential provider is created after establishing the message communication channel, thereby the API communication and the messages between the program “LogonUI.exe” and the customized credential provider can be smoothly transferred to the password credential provider provided by the OS (S613).

In the meantime, the user(s) can perform the multi-factor authentication procedure on the logon screen having the multi-factor authentication window (S615).

After successfully identifying the user, the user ID/password is transmitted in accordance with the authentication database and the customized credential provider is informed through the message communication channel (S617).

Next, the customized credential provider of the present invention calls an API: CredentialsChanged( ) , and informs the program “LogonUI.exe” to refresh all the credentials provided by the credential provider(s) (S619).

In the meantime, the customized credential provider further calls APIs, such as GetCredentialCount( ) and GetCredentialAt( ), and retrieves the number of password credentials and corresponding information (S621). Then the process verifies every user ID with the transmitted ID from the multi-factor authentication procedure. If the step cannot identify the user, the process returns to step S607 after an error message is generated. If a password credential of the user is verified, a customized credential of the account and a wrapped password credential are created (S623).

The above-mentioned program “LogonUI.exe” retrieves the customized credential via the well-defined API: GetCredentialAt( ) (S625). Next, the customized credential refills the password of the corresponding user ID into the wrapped password credential and retrieves the authentication package (S627). Finally, the logon is executed according to the authentication package (S629).

### Embodiment 2

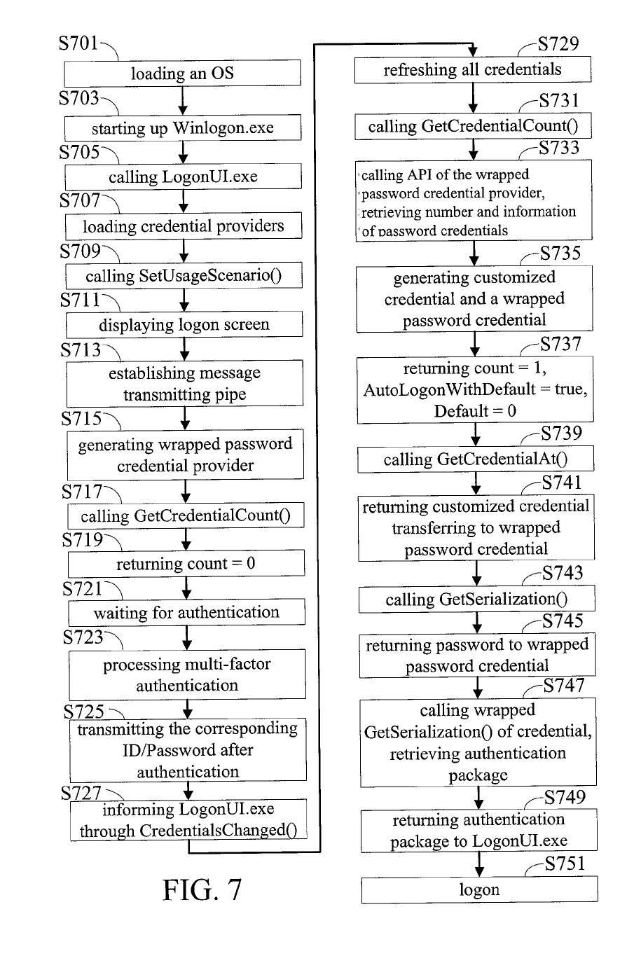

During the logon procedure, the data transmitted between the program “LogonUI.exe” and the credential provider of the Windows® OS adopts (call) some APIs, as shown in the flowchart shown in FIG. 7. The method shown in FIG. 7 is essentially applied for user authentication of Windows Vista™ OS. The preferred embodiment includes a first step of loading the operating system by booting the system (S701). Next, the program “Winlogon.exe” activates Windows® logon procedure (S703).

After that, the computer system can communicate with the logon screen of Windows Vista™ OS, wherein the program “Winlogon.exe” calls the LogonUI procedure for processing the Windows® logon procedure and collects the credential information of each registered account. The information, for example, includes the credential number, the access privilege of system resources with a corresponding credential. Next, the step draws a logon screen and interacts with the authentication module of the OS (S705).

Next, the credential providers of the Windows Vista™ operating system are loaded. The credential providers include the standard password credential provider of the Windows® OS and the customized credential provider of the present invention (S707).

Next, the program “LogonUI.exe” calls the API: SetUsageScenario( ) for each credential provider. Thereby the program “LogonUI.exe” communicates with each credential provider to determine whether or not the credential provider supports the functionality, so as to define the environment as the credential(s) for logging on to the operating system (S709). The transmitted parameters include (1) CPUS_LOGON, for displaying the logon screen after booting or logging out, and users can choose the listed account thereon; (2) CPUS_UNLOCK_WORKSTATION, for unlocking the system, which is locked after the user logs on the system through an account; (3) CPUS_CREDUI, for showing a popup window of a UAC (User Account Control). If a user having lower permission wants to process a higher-permission function, for example, to add new account, in this Windows Vista™ OS, the UAC will popup an administrator window for verifying the permission. The user then can process the higher-permission function after verification.

Next, the program “LogonUI.exe” draws the logon tiles on the logon screen based on the credential information and the multi-factor authentication window. Thereby, the multi-factor authentication window and the original logon window are shown in the same screen (S711).

Next, a message communication channel is established between the multi-factor authentication procedure and the customized credential provider (S713). The preferred embodiment of the message communication channel establishes an encrypted channel therebetween, which adopts a pipe mechanism, a message mechanism, or a shared memory mechanism.

In the meantime, the customized credential provider establishes a wrapped password credential provider for transferring API messages from the customized credential provider to the password credential provider in the operating system in the period of authentication procedure. Therefore, the multi-factor authentication method can be incorporated into the original password authentication system smoothly (S715).

Next, the program “LogonUI.exe” calls API: GetCredentialCount( ) for retrieving the number of credentials provided by each credential provider. The credential indicates the logon credential drawn on the logon screen. The total credential number is a sum of the credential number returned by the password credential provider and the credential number returned by the customized credential provider (S717).

In S717, the API: GetCredentialCount( ) is called for retrieving the credential number. At this time, the customized credential provider returns the parameters such as count=0 and AutoLogonWithDefault=False, which indicates the customized credential provider doesn't provide any customized credential for the program “LogonUI.exe” to show on the logon screen. Only the original credential(s) are shown on the logon screen (S719), and the process waits for the user(s) to process the authentication, which includes both the multi-factor authentication and a conventional authentication using user ID/password (S721).

Next, a user processes the multi-factor authentication procedure. In addition to the conventional logon method using a user ID/password, the procedure also provides third-party authentication methods, such as biometric verification, a smart card, or other equivalent authentication methods (S723).

Then the user is successfully identified when he or she follows the indications shown on the multi-factor authentication window and processes the authentication procedure, such as scanning a fingerprint, capturing a facial image, inputting a smart card, or the like, in order. Otherwise, if the user is not identified, an error message will be shown and the process will return to S711 and display the logon screen and process the authentication procedure again.

After successfully verifying the user's identity and comparing it with the information stored in the authentication database, the authentication system will inform the credential provider and send the user ID/password through the message communication channel (S725).

Next, the customized credential provider receives the user ID/password through the mentioned message communication channel and informs the program “LogonUI.exe” via the API: CredentialsChanged( ) (S727). After that, the program “LogonUI.exe” refreshes all the credentials provided by the credential provider(s) (S729).

Again, the program “LogonUI.exe” calls API: GetCredentialCount( ) (S731), and the customized credential provider of the present invention calls APIs: GetCredentialCount( ), GetCredentialAt( ) of the established wrapped password credential provider(s) for retrieving the credential number and information (S733).

Next, after verifying the credential(s) of the authenticated user individually, a customized credential and a wrapped password credential of the user are created (S735).

Next, the customized credential provider returns the values of GetCredentialCount( ) parameters: “count”, “AutoLogonWithDefault” and “Default”. Wherein the count=1 indicating that a credential is created to be shown, Default=0 indicating that the default login user is the first credential, AutoLogonWithDefault=True indicating that the program “LogonUI.exe” is using the default credential to process the logon procedure automatically (S737).

Next, the program “LogonUI.exe” calls API: GetCredentialAt( ) of the customized credential provider, and sends Index=0 to obtain the first customized credential for automatically logon (S739).

When the program “LogonUI.exe” uses the well-defined interface to communicate with the customized credential, this customized credential will transfer the request API to the created wrapped password credential (S741).

Next, the program “LogonUI.exe” calls API: GetSerialization( ) of the customized credential (S743), and the customized credential refills the corresponding user ID/password into the password fields of the wrapped password credential (S745).

Finally, the program “LogonUI.exe” calls API: GetSerialization( ) of the wrapped password credential for obtaining an authentication package (S747), and then the authentication package is returned to the program “LogonUI.exe” (S749). Whereby, the last step S751 logs on to the system.

To sum up, the multi-factor authentication system and a logon method of the Windows® OS is applied to the Windows Vista™ operating system and the later OS which adopts the credential provider authentication mechanism. Without any influence upon a user's behavior, the present invention provides a multi-factor authentication window shown on the original logon screen of the Windows® OS. Whereby, the multi-factor authentication method establishes a more convenient and more secure logon method. In the preferred embodiment of the present invention, the user uses the multi-factor authentication means to create a password credential instantly after identifying the user, and to refill the corresponding user ID/password for logging on to the system.

Consequently, the advantages of the present invention are:
1. The interactive logon screen;
2. Support for multi-factor logon, and being able to transmit corresponding passwords to the credential provider; the procedure conforming to the authentication procedure of the Windows Vista™ operating system without any influence upon the user's behavior;
3. Automatic logging on to the Windows® operating system via the multi-factor authentication method;
4. The system is stable since the method uses the program provided by the original OS;
5. Generating the required directories and their access privileges as logging on to the operating system;
6. Default authentication method is still adopted by means of the user ID/password;
7. Able to create a customized logon screen;
8. More secure authentication mechanism;
9. Users can choose a suitable authentication method since the multi-factor authentication window can have a plurality of authentication functionalities.

The many features and advantages of the present invention are apparent from the written description above and it is intended by the appended claims to cover all. Furthermore, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A multi-factor authentication system for a Windows® OS, comprising:
means for logging on to a Windows OS via a logon program “Winlogon.exe”, and establishing a Windows logon procedure;
means for logging on to a user interface, the Windows logon procedure calling “LogonUI.exe” for installing a credential provider of the Windows® OS;
means for authenticating using the credential provider for describing the user interface of a credential, and collecting information about the credential, before being sent to the Windows logon procedure;
means for displaying a logon screen having a multi-factor authentication window, which is created by a customized credential provider, on the default conventional logon screen;
means for multi-factor authentication, wherein a multi-factor authentication procedure is established by the multi-factor authentication window;
means for identifying a user by comparing the user information produced from the multi-factor authentication procedure with the user's information registered in an authentication database;
means for refilling the user ID/password stored in the authentication database with a corresponding user in the multi-factor authentication procedure into an ID/password field in the Windows logon procedure; and
means for messaging between the multi-factor authentication procedure and the credential provider through a message communication channel.

2. The system of claim 1, wherein the multi-factor authentication window includes a plurality of authentication graphic items for indicating a number of selectable multi-factor functions.

3. The system of claim 1, wherein the Windows® OS is a Windows Vista™ operating system or the later OS that adopts an authentication model of the credential provider.

4. The system of claim 1, wherein the means for multi-factor authentication includes a smart card requiring an access code or ID, a token card, a biometric verification such as s palm print, an iris scan, a retina scan, a facial scan, an auricle scan, voiceprint recognition, a fingerprint scan, a vein distribution scan of a finger, a palm or a back of a hand, and the like.

5. The system of claim 1, wherein the means for refilling the ID/password uses the message communication channel to refill the user ID/password into the ID/password field in the Windows logon procedure.

6. The system of claim 1, wherein the means for messaging is implemented by a pipe mechanism, which embodies the message communication channel between the multi-factor authentication procedure and the credential provider of the Windows® operating system.

7. The system of claim 1, wherein the means for messaging is implemented by a message mechanism, which queries or receives a queue message between the multi-factor authentication procedure and the Windows logon procedure.

8. The system of claim 1, wherein the means for messaging is a shared memory mechanism that uses a shared memory to transfer a message between the multi-factor authentication procedure and the Windows logon procedure.

9. The system of claim 1, wherein the message communication channel is an encrypted secure channel.

10. A logon method for a multi-factor authentication system of a Windows® OS, comprising:
loading a Windows® operating system after booting;
activating a Windows logon procedure via a logon program “Winlogon.exe”;
calling a logon user interface program “LogonUI.exe”;
loading one or a plurality of credential providers that include the password credential provider provided by the Windows® OS, and at least one customized credential provider;
displaying a logon screen provided by the customized credential provider, wherein the logon screen has a multi-factor authentication window;
establishing a message communication channel between the multi-factor authentication procedure and the credential provider;
creating a wrapped password credential provider for transferring the authentication message to the password credential provider;
processing a multi-factor authentication procedure using the multi-factor authentication window;
after identifying the user, comparing the information stored in an authentication database with a corresponding registered user through the message communication channel, informing the credential provider, and sending out the user ID/password;
informing the “LogonUI.exe” to reload all the credential providers;
the customized credential provider calling API of the wrapped password credential provider for retrieving number of the password credentials and their information;
creating a customized credential and a wrapped password credential;
the customized credential refilling password into the password field of the wrapped password credential, and retrieving an authentication package; and
logging on to the system.

11. The method of claim 10, wherein the step of “LogonUI.exe” loading the credential providers, the status of CPUS_LOGON, CPUS_UNLOCK_WORKSTATION and CPUS_CREDUI are included.

12. The method of claim 10, wherein after the multi-factor authentication procedure, if the user is not identified, the method displays the logon screen to process the authentication procedure again.

13. The method of claim 10, wherein the logon screen includes a plurality of graphic items for providing selectable multi-factor functions.

14. The method of claim 10, wherein the Windows® OS is a Windows Vista™ operating system or the later OS that adopts an authentication model of the credential provider.

15. The method of claim 10, wherein the multi-factor authentication includes a smart card requiring an access code or ID, a token card, and a biometric verification such as palm print, iris, retina, facial, auricle, voiceprint, fingerprint, vein distribution of the finger, palm or back of hand, and the like.

16. The method of claim 10, wherein the message communication channel is implemented by a pipe mechanism, which embodies the message transmission between the multi-factor authentication procedure and the Windows logon procedure.

17. The method of claim 10, wherein message communication channel is implemented by a message mechanism, which queries or receives a queue message between the multi-factor authentication procedure and the credential provider.

18. The method of claim 10, wherein a message communication channel is implemented by a shared memory mechanism that uses a shared memory to transfer the message between the multi-factor authentication procedure and the Windows logon procedure.

19. The method of claim 10, wherein the message communication channel is an encrypted secure channel.

20. A logon method of a multi-factor authentication system for logging on to a Windows Vista™ OS, comprising:
loading the Windows Vista™ OS after booting;
activating a Windows logon procedure;
calling LogonUI.exe;
loading a password credential provider of the Windows Vista™ OS and at least one customized credential provider;
the “LogonUI.exe” calling API: SetUsageScenario( ) for each credential provider;
displaying a logon screen having a multi-factor authentication window;
establishing a message communication channel between a multi-factor authentication procedure and the credential provider;
creating a wrapped password credential provider;
the “LogonUI.exe” calling API: GetCredentialCount( );
returning count=0, and AutoLogonWithDefault=False;
processing the multi-factor authentication procedure;
after identifying the user, comparing the information stored in an authentication database with a corresponding registered user through the message communication channel, informing the credential provider, and sending out the user ID/password;
informing “LogonUI.exe” to reload the credentials provided by the credential provider through API:CredentialsChanged( );
the “LogonUI.exe” calling API:GetCredentialCount( );
creating a customized credential and a wrapped password credential;
returning count=1, AutoLogonWithDefault=True, Default=0;
returning the customized credential to “LogonUI.exe”;
the “LogonUI.exe” calling GetSerialization( ) of the customized credential;
the customized credential refilling API:GetSerialization( ) of the wrapped password credential, and retrieving an authentication package corresponding to the password credential, and sent to LogonUI.exe; and
logging on.

21. The method of claim 20, wherein the parameters transferred to SetUsageScenario( ) are CPUS_LOGON, CPUS_UNLOCK_WORKSTATION, CPUS_CREDUI.

22. The method of claim 20, wherein if the identification fails, the method goes to the step of displaying the logon screen and processing the authentication again.

23. The method of claim 20, wherein the multi-factor authentication window includes a plurality of graphic items that indicate the selectable multi-factor authentication functions.

24. The method of claim 20, wherein the multi-factor authentication includes a smart card requiring an access code or ID, a token card, and a biometric verification such as palm print, iris, retina, facial, auricle, voiceprint, fingerprint, vein distribution of the finger, palm or back of hand, and the like.

25. The method of claim 20, wherein the message communication channel is implemented by a pipe mechanism, which embodies the message transmission between the multi-factor authentication procedure and the Windows logon procedure.

26. The method of claim 20, wherein the message communication channel is implemented by a message mechanism, which queries or receives a queue message between the multi-factor authentication procedure and the credential provider.

27. The method of claim 20, wherein the message communication channel is implemented by a shared memory mechanism that uses a shared memory to transfer the message between the multi-factor authentication procedure and the Windows logon procedure.

28. The method of claim 20, wherein the message communication channel is an encrypted secure channel.
